(19) United States
(12) Patent Application Publication
(10) Pub. No.: US 2017/0003754 A1
(43) Pub. Date: Jan. 5, 2017

(54) METHOD AND ASSEMBLY FOR USING SWITCHABLE BACKLIGHTING TO DISTINGUISH BETWEEN MULTI-FUNCTION KEYS

(71) Applicant: Lenovo (Singapore) Pte. Ltd., New Tech Park (SG)

(72) Inventors: Matthew Geary, Raleigh, NC (US); Thomas Sluchak, Apex, NC (US); Christopher Osborne, Cary, NC (US)

(21) Appl. No.: 14/790,874

(22) Filed: Jul. 2, 2015

(51) Int. Cl. G06F 3/02; G06F 3/023; F21V 33/00

(52) U.S. Cl. CPC G06F 3/0202; G06F 3/0227; F21V 33/0052; G06F 3/0238

(57) ABSTRACT

Systems, devices, and methods described herein provide an input device having keys operatively coupled with light devices that emit light out of the keys. The input device is associated with different modes of operation. The light devices emit the light out of the keys responsive to a selected mode of operation being a first mode of operation. The light devices stop emitting the light out of the keys responsive to the selected mode of operation being a different, second mode of operation. The light devices are activated to indicate the selected mode of operation. One or more processors perform first functions associated with the keys during the first mode of operation and perform different, second functions associated with the same keys during the second mode of operation.

### FIELD

Embodiments of the present disclosure generally relate to input devices of a computing assembly, such as keyboards.

### BACKGROUND

Computers can include keyboards to receive input from users of the computer. The keyboards include several keys associated with different sets of functions. For example, in one mode of operation, pressing the “A” key causes the lowercase letter “a” to be input into the computer. Different modes of operation of the computer can cause the actuation of the same key to produce different functions. For example, in another mode of operation (such as when the “Shift” key is concurrently depressed), pressing the “A” key causes the uppercase letter “A” to be input into the computer.

Some keys are associated with different functions that may not be readily understood or memorized by users. For example, pressing the “F2” key alone may cause the last action taken by the computer to be undone (such as by removing the last text string that was input into a word processing program), while concurrently pressing the “Control” and “F2” key can cause the word processing program to open a print dialog screen or concurrently pressing the “Control” key, the “Alternate” key, and the “F2” key can cause the word processing program to prompt the user to open another file.

The number of functions that can be associated with the same keys or combination of keys can be large and difficult for users to memorize. While some keys do include labels printed on the keys that indicate some of the functions associated with the keys, these printed labels are static and do not change when the functions of the key changes. For example, while the “F2” key may have indicia printed thereon stating “Undo” or the like, to represent the function of undoing the last user action, it may not be possible for indicia to be printed on the “F2” key to indicate the changing functions of the key when combinations of one or more other keys also are depressed along with the “F2” key. As a result, a user may need to refer to a list or table of the various functions associated with different combinations of key presses, which can be a time consuming and laborious chore for the user.

### BRIEF SUMMARY

In accordance with one embodiment, a system includes an input device and one or more processors. The input device includes keys operatively coupled with first light devices that emit first light out of the keys. The input device is associated with different modes of operation. The one or more processors activate the first light devices to emit the first light out of the keys responsive to a selected mode of operation being a first mode of operation. The one or more processors deactivate the first light devices to stop emitting the first light out of the keys responsive to the selected mode of operation being a different, second mode of operation. The one or more processors activate the first light devices to indicate the selected mode of operation. The one or more processors perform first functions associated with the keys during the first mode of operation responsive to actuation of the first keys. The one or more processors perform different, second functions associated with the keys during the second mode of operation and responsive to actuation of the first keys.

In one embodiment, a device includes keys and first light devices. The keys are associated with different functions in different modes of operation performed by a system such that activation of the keys during a first mode of operation causes the system to perform first functions and actuation of the first keys during a second mode of operation causes the system to perform different, second functions. The first light devices are operatively coupled with the keys. The first light devices emit first light out of the keys responsive to operation in the first mode of operation. The first light devices emit the first light to indicate the first mode of operation. The first light devices do not emit the first light out of the keys responsive to the keys operating in the second mode of operation.

In one embodiment, a method includes forming a first light transmissive window in an exterior coating of a key in an input device of a system, placing a first light device in the key such that the first light device emits light out of the key through the first light transmissive window responsive to activation of the first light device, and operatively coupling the first light device in the key with one or more processors of the system such that the one or more processors control the activation the first light device to emit the light out of the key responsive to a selected mode of operation being a first mode of operation and to stop emitting the light out of the key responsive to the selected mode of operation being a different, second mode of operation.

### BRIEF DESCRIPTION OF THE DRAWINGS

FIG. 1 illustrates one embodiment of a system.

FIG. 2 is a top view of a key shown in FIG. 1 according to one example.

FIG. 3 is a top view of the key shown in FIG. 2.

FIG. 4 is a cross-sectional view of the key along line 4-4 shown in FIG. 2 according to one embodiment.

FIG. 5 illustrates a bottom view of a key according to another embodiment.

FIG. 6 illustrates a flowchart of one embodiment of a method for manufacturing a key for an input device of a system.

FIG. 7 illustrates the key shown in FIG. 1 following an operation of the method shown in the flowchart of FIG. 6.

FIG. 8 illustrates the key shown in FIG. 1 following another operation of the method shown in the flowchart of FIG. 6.

FIG. 9 illustrates the key shown in FIG. 1 following another operation of the method shown in the flowchart of FIG. 6.

FIG. 10 illustrates the key shown in FIG. 1 following another operation of the method shown in the flowchart of FIG. 6.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

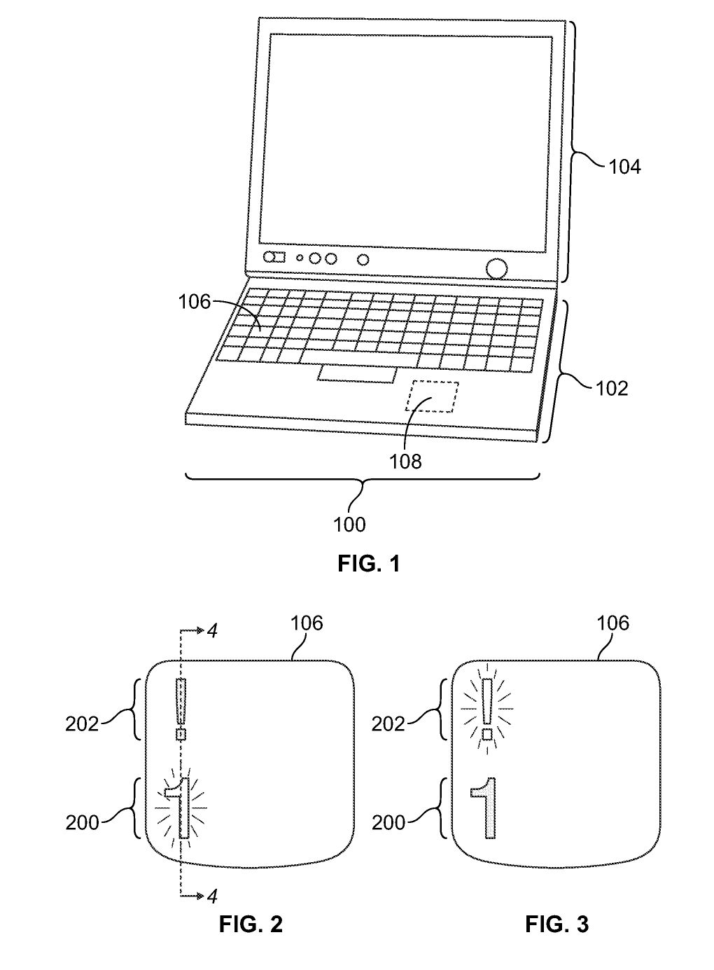

FIG. 1 illustrates one embodiment of a system 100. The system 100 shown in FIG. 1 is a laptop computer, but optionally may be a desktop computer, a tablet computer, a mobile phone, or other electronic device or device. The system 100 includes an output device 104, such as an electronic display device (e.g., a touchscreen, monitor, non-touchscreen display, etc.). An input device 102 of the system 100 can be used by a user of the system 100 to input information to the system 100. The input device 102 is illustrated as a keyboard having plural keys 106 that, when actuated by pressing on the keys 106, cause the input device 102 to provide different inputs to the system 100. Responsive to the inputs, the system 100 performs various functions. For example, different keys 106 may cause the system 100 to perform different functions based on a current mode of operation (also referred to as a selected mode of operation) of the input device 102 and/or system 100.

For example, actuating different ones or combinations of the “Shift” key 106, the “Control” key 106, the “Alternate” key 106, the “Capitalization lock” key 106, the “Number lock” key 106, or other key 106 can cause the input device 102 and/or system 100 to change modes of operation. Pressing one or more of these keys 106 or another key 106 in combination with actuation of a selected key 106 (e.g., a key representing a letter, number, or symbol) can result in different functions being performed by the system 100. As described and shown herein, the keys 106 may include light devices inside the keys 106 that are activated or deactivated to indicate to a user which function will be performed responsive to actuation of different keys 106. For example, in a first mode of operation of the system 100 and/or input device 102, pressing the key 106 associated with the number “1” can result in the number “1” being input to and displayed on the output device 104. Responsive to pressing the “Shift” key 106, however, the mode of operation changes to a second mode of operation. In the second mode of operation, a light device inside the key 106 associated with the number “1” can begin emitting light that exits from a light transmissive window in the key 106. This window can be in the shape of the explanation point symbol “!” to notify a user that pressing the “1” key 106 will result in the explanation point symbol “!” to be input to the system 100 instead of the number “1” being input. Releasing the “Shift” key 106 can cause the system 100 and/or input device 102 to revert back to the first mode of operation (where pressing the “1” key 106 results in the number “1” being input into the system). The light device inside the “1” key 106 may deactivate such that light is no longer generated responsive to returning to the first mode of operation.

In one aspect, the modes of operation of the input device 102 (and the lights generated inside the keys 106) change responsive to a combination of keys 106 being concurrently actuated. For example, pressing the “Shift” key 106, “Control” key 106, or “Alternate” key 106 alone can result in a change in the mode of operation of the system 100 and/or input device 102, and pressing a combination of the “Shift” key 106, “Control” key 106, and/or “Alternate” key 106 can result in a change in the mode of operation of the input device 102 and/or system 100.

Optionally, changing a mode of operation may cause actuation of one or more keys 106 to perform an editing function. For example, actuating the “Control” key 106 may change the mode of operation such that, upon then actuating the “X” key 106, a portion of alphanumeric text and/or symbols shown on the output device 104 may be cut from the document being edited on the output device 104.

In addition to or as an alternate to a single light device inside the key 106 activating or deactivating responsive to changing modes of operation. Keys 106 can each include multiple light devices, with different light devices and/or different combinations of light devices being activated or deactivated responsive to changing modes of operation. Optionally, a color of light generated inside a key 106 may change responsive to a change in the mode of operation. In one aspect, only a single light device within a key 106 is activated or deactivated, and/or changes color, responsive to a mode of operation changing. Alternatively, two or more light devices within each key 106 or at least one key is activated and/or changes color responsive to a mode of operation changing.

One or more processors 108 may be included in the input device 102 and/or system 100 to detect actuation of the keys 106, determine the mode of operation of the system 100 and/or input device 102, and/or to direct the output device 104 to display various alphanumeric symbols or other symbols responsive to actuation of one or more keys 106 and based on the selected mode of operation. The one or more processors 108 can represent one or more microprocessors, controllers, field programmable gate arrays, switches, or the like. In one aspect, the one or more processors 108 can represent two or more different devices performing different functions. For example, the one or more processors 108 can represent switches that are controlled to change the mode of operation of the input device 102 and one or more microprocessors that identify actuations of keys 106 and direct the output that is displayed on the output device 104 based on the mode of operation and which key 106 or keys 106 are actuated.

FIG. 2 is a top view of one of the keys 106 shown in FIG. 1 according to one example. In a first mode of operation of the input device 102 and/or system 100 shown in FIG. 1, a first light device is activated within the key 106 to cause light to exit the key 106 through a first light transmissive window 200 in the key 106. The first light transmissive window 200 shown in FIG. 2 is in the shape of the number “1.” As a result, the light exiting from the key 106 generates a lighted shape of the number “1.” A user looking at the key 106 would understand that, in the current mode of operation of the input device 102 and/or system 100, actuating the key 106 shown in FIG. 2 will cause the number “1” to be provided to the system 100 as input from the input device 102.

The key 106 also includes a second light transmissive window 202. The second light transmissive window 202 shown in FIG. 2 is in the shape of the explanation point symbol “!” The light device within the key 106 that is associated with the second light transmissive window 202 is not activated to generate light during the time that the input device 102 and/or system 100 operates in the first mode of operation. Therefore, light is not exiting from the key 106 through the second light transmissive window 202. In one embodiment, while some light may exit from the key 106 through the second light transmissive window 202 during operation in the first mode of operation, the amount of light exiting through the second light transmissive window 202 is dimmer relative to the light exiting through the first light transmissive window 200 so as to avoid confusion as to which function will be performed by pressing the key 106 in the first mode of operation.

FIG. 3 is a top view of the key 106 shown in FIG. 2. In a second mode of operation of the input device 102 and/or system 100 shown in FIG. 1, a second light device is activated within the key 106 to cause light to exit the key 106 through the second light transmissive window 202 in the key 106. As a result, the light exiting from the key 106 generates a lighted shape of the explanation point symbol “!”. A user looking at the key 106 would understand that, in the current mode of operation of the input device 102 and/or system 100, actuating the key 106 shown in FIG. 2 will cause the symbol “!” to be provided to the system 100 as input from the input device 102.

Optionally, the key 106 may include a different number of light transmissive windows 200, 202 (or even a single light transmissive window 200, 202) and/or a different number of light devices (or even a single light device). For example, the symbol representing a first function to be performed by pressing the key 106 in a first mode of operation (e.g., the number “1”) may be printed on the key 106 and the second light transmissive window 202 may be provided to represent the explanation point symbol “!” in the second mode of operation. During the first mode of operation, the light device inside the key 106 may not generate light so that light does not exit the key 106 through the second light transmissive window 202, while in the second mode of operation, the light device is activated to generate light so that light does exit the key 106 through the second light transmissive window 202.

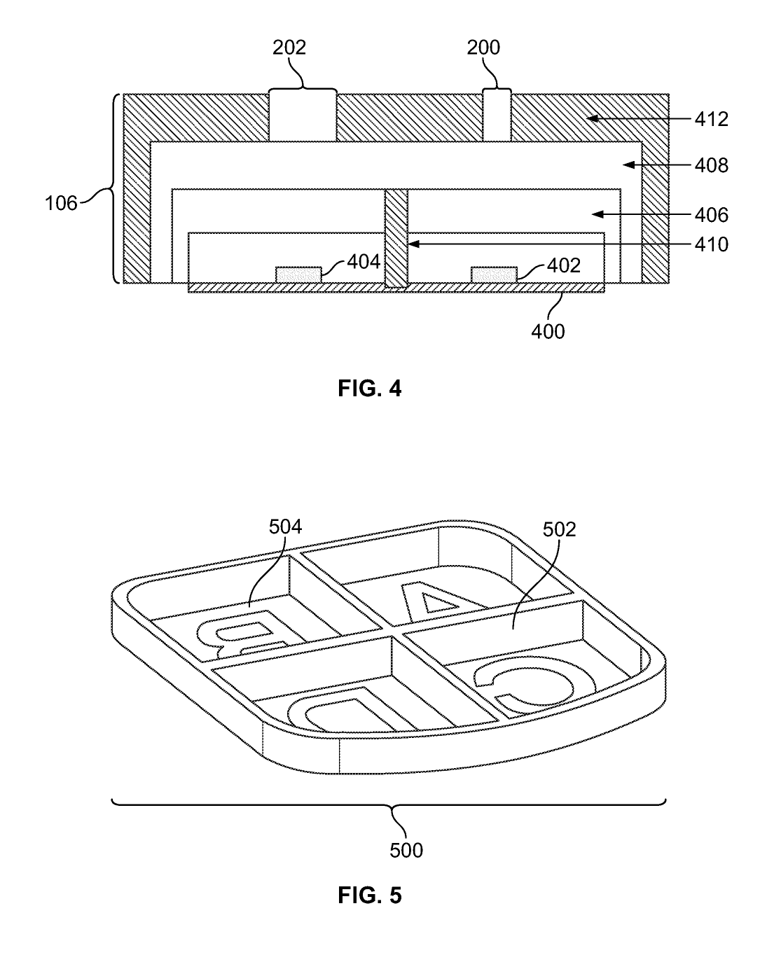

FIG. 4 is a cross-sectional view of the key 106 along line 4-4 shown in FIG. 2 according to one embodiment. The key 106 includes a substrate 400 that supports one or more light devices 402, 404 inside the key 106. Optionally, a different number of light devices 402, 404 or a single light device 402, 404 may be inside the key 106. The substrate 400 may represent or include a printed circuit board that is operatively coupled with the light devices 402, 404 to power and control the light devices 402, 404. The light devices 402, 404 can represent light emitting devices (LEDs) or another type of light device. The light generated by the different light devices 402, 404 can be the same color of light or different colored lights.

A key cover 406 is positioned over the light devices 402, 404 such that the light devices 402, 404 are between the substrate 400 and the key cover 406. The key cover 406 can be clear to permit light to pass through the cover 406. The key cover 406 may include an interior coating 408 that changes the color of the light generated by the light devices 402, 404. This coating 408 may be a painted coating of a semi-opaque color. The coating 408 can change the color of the light generated by the light devices 402, 404 to a different light that exits the key 106 through the light transmissive windows 200, 202. The coating 408 may be the same color between both light devices 402, 404 and the light transmissive windows 200, 202, or may have different colors between one light device 402 and the light transmissive window 200 and between the other light device 404 and the light transmissive window 202. Alternatively, the coating 408 may not be included in the key 106.

A light dam 410 is positioned between the light devices 402, 404. The light dam 410 represents a block or other body that is located between the light devices 402, 404. The light dam 410 assists in preventing or prevents the light generated from one light device 402, 404 from exiting the key 106 through a light transmissive window 200, 202 associated with another light device 402, 404. For example, the light dam 410 can help prevent or prevent the light generated by the light device 402 from exiting the key 106 through the light transmissive window 202 and/or can prevent or help prevent the light generated by the light device 404 from exiting the key 106 through the light transmissive window 200. In one aspect, the coating 408 on the cover 406 may diffract the light generated by the light devices 402, 404 such that light generated by the light device 402 is blocked by the light dam 408 and diffracted by the coating 408 such that little to no light generated by the light device 402 exits the key 106 through the light transmissive window 202 and light generated by the light device 404 is blocked by the light dam 408 and diffracted by the coating 408 such that little to no light generated by the light device 404 exits the key 106 through the light transmissive window 200. While some light generated by the light device 402 may exit from the key 106 through the light transmissive window 202 and/or some light generated by the light device 404 may exit from the key 106 through the light transmissive window 200, the amount of light from the light device 404 exiting through the light transmissive window 200 may be dimmer than the light from the light device 402 that exits through the light transmissive window 200, and the light from the light device 402 exiting through the light transmissive window 202 may be dimmer than the light from the light device 404 that exits through the light transmissive window 202.

An exterior coating 412 may be provided on the coating 408 of the key 406 or directly on the key 406. The exterior coating 412 can include an opaque paint or other coating on the coating 408 or key 406. The light transmissive windows 200, 202 can be formed by cutting away portions of the exterior coating 412, such as by ion etching through an entire thickness of the exterior coating 412. Optionally, the exterior coating 412 can be printed or painted on the coating 408 or key 406 without covering all of the coating 408 or key 406 such that the light transmissive windows 200, 202 are formed.

FIG. 5 illustrates a bottom view of a key 500 according to another embodiment. The key 500 can represent one or more of the keys 106 shown in FIG. 1. Similar to the key 106, the key 500 includes several light transmissive windows 504 through which light generated by light devices 402, 404 (shown in FIG. 4) can exit from the key 500 to indicate what function or functions are performed responsive to actuating the key 500. The light transmissive windows 504 can be formed in a manner similar or different from the light transmissive windows 200, 202 (shown in FIG. 2).

In contrast to the key 106 shown in FIGS. 2 and 3, the key 500 includes four light transmissive windows 504 and multiple light dams 502. The light dams 502 can prevent or reduce the amount of light generated by a light device 402, 404 not associated with a light transmissive window 504 from exiting the key 500 through that light transmissive window 504. In doing so, the user of the system 100 (shown in FIG. 1) can more clearly see what function is to be performed by actuation of the key 500 based on the selected mode of operation.

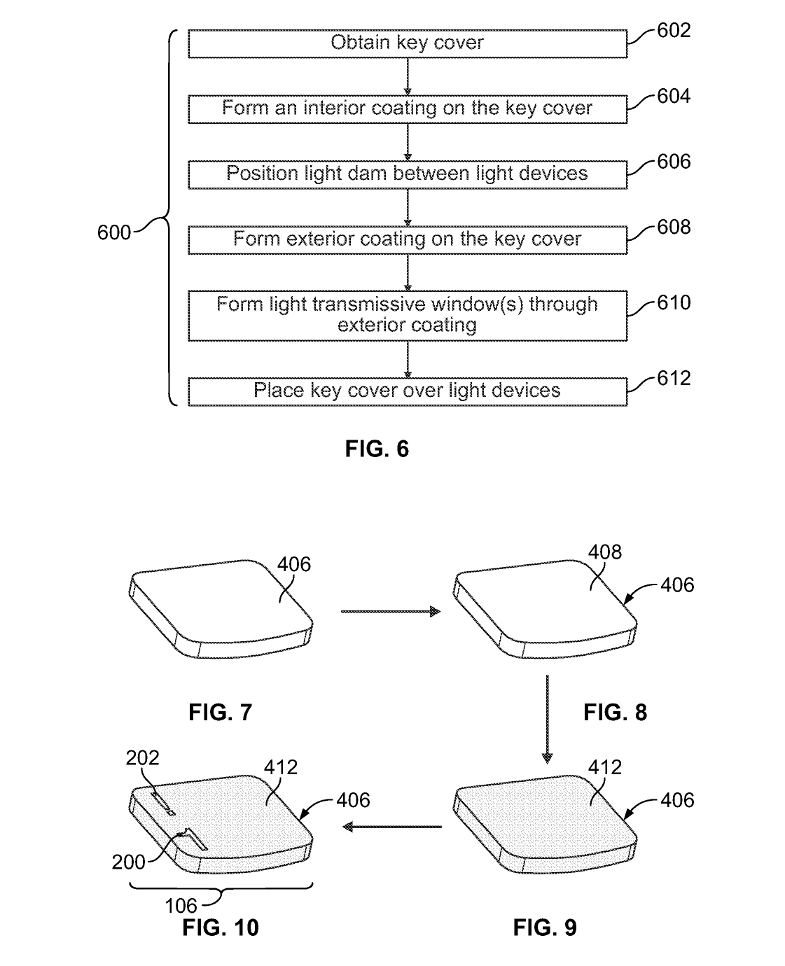

FIG. 6 illustrates a flowchart of one embodiment of a method 600 for manufacturing a key for an input device of a system. The method 600 may be used to form one or more embodiments of the keys 106, 500 shown in FIGS. 1 and 6, or to form another type of key. At 602, a key cover is obtained. As described above, the key cover may be light transmissive to permit light to pass there through.

With continued reference to the flowchart of the method 600 shown in FIG. 6, FIGS. 7 through 10 illustrate the key 106 following different operations of the method 600 shown in FIG. 6. FIG. 7 illustrates the key cover 406 that is obtained at 602 in the method 600 according to one embodiment. At 604 in the flowchart of the method 600 shown in FIG. 6, an interior coating is formed on the key cover. FIG. 8 illustrates the key cover 406 with the interior coating 408 disposed thereon according to one embodiment. The interior coating 408 may be painted, printed, or otherwise applied to an exterior surface of the key cover 406.

At 606 in the flowchart of the method 600 shown in FIG. 6, one or more light dams are positioned between light devices. For example, one or more of the light dams 410, 502 shown in FIGS. 4 and 5 may be positioned between the light devices 402, 404 shown in FIG. 4. The light dams may be coupled with the key cover 406 and/or the substrate 400 (shown in FIG. 4).

At 608, an exterior coating is formed on the key cover. FIG. 9 illustrates the key cover with the exterior coating disposed thereon according to one embodiment. The exterior cover 412 may be painted or printed on the interior coating 408 of the key cover 406. Alternatively, the interior coating 408 may not be applied to the key cover 406 and the exterior coating 412 may be applied directly to the key cover 406.

At 610 of the flowchart of the method 600 shown in FIG. 6, one or more light transmissive windows are formed in the exterior cover. FIG. 10 illustrates the key 106 with the light transmissive windows 202, 204 formed therein according to one embodiment. The light transmissive windows 202, 204 may be formed by etching through the exterior coating 412. Alternatively, the light transmissive windows 202, 204 may be formed by printing or painting the exterior coating 412 onto the interior coating 408 and/or key cover 406 such that no exterior coating 412 is applied in locations where the light transmissive windows 202, 204 are to be located.

At 612 of the flowchart of the method 600 shown in FIG. 6, the key cover is positioned over the light devices. The key cover 406 with the coatings 408, 412 having the light transmissive windows 202, 204 can be placed over the light devices 402, 404 to form the key 106.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.”

Aspects are described herein with reference to the figures, which illustrate example methods, devices and program products according to various example embodiments. Although illustrative example embodiments have been described herein with reference to the accompanying figures, it is to be understood that this description is not limiting and that various other changes and modifications may be affected therein by one skilled in the art without departing from the scope or spirit of the disclosure.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

1. A system comprising:
an input device including a key operatively coupled with a first light device and a second light device; and
one or more processors activating the first light device to emit a first light out of the key responsive to a selected mode of operation being a first mode of operation and activating the second light device to emit a second light out of the key responsive to the selected mode of operation being a different, second mode of operation.

2. The system of claim 1, wherein the key includes a light transmissive window through which the first light is emitted from the key.

3. The system of claim 2, wherein the key includes one or more light dams that prevent the second light from emitting from the key through the light transmissive window.

4. The system of claim 1, wherein the one or more processors perform a first function associated with the key responsive to actuation of the key during the first mode of operation and the one or more processors perform a different, second function associated with the key responsive to actuation of the key during the second mode of operation.

5. The system of claim 1, wherein the key includes a first light transmissive window through which the first light is emitted from the key and a second light transmissive window through which the second light is emitted from the key.

6. The system of claim 1, further comprising an output device displaying output to a user responsive to actuation of the key, wherein the one or more processors direct the output device to display a first output responsive to actuation of the key during operation in the first mode of operation and the one or more processors direct the output device to display a different, second output responsive to actuation of the key during operation in the second mode of operation.

7. The system of claim 6, wherein the one or more processors direct the output device to display an alphanumeric symbol as the first output responsive to the actuation of the key during operation in the first mode of operation and the one or more processors direct the output device to perform an editing function of alphanumeric symbols displayed on the output device responsive to the actuation of the key during operation in the second mode of operation.

8. An input device comprising:
keys associated with different functions in different modes of operation performed by a system such that activation of the keys during a first mode of operation causes the system to perform first functions and actuation of the first keys during a second mode of operation causes the system to perform different, second functions;
first light devices and second light devices operatively coupled with the keys; and
one or more processors activating the first light devices to emit first light out of the keys responsive to operation in the first mode of operation, the first light devices emitting the first light to indicate the first mode of operation, the first light devices not emitting the first light out of the keys responsive to the keys operating in the second mode of operation, the one or more processors also activating the second light devices to emit a different, second light out of the keys responsive to the keys operating during the second mode of operation.

9. The input device of claim 8, wherein the keys include light transmissive windows through which the first light is emitted from the keys during the first mode of operation.

10. (canceled)

11. The input device of claim 8, wherein the keys include first light transmissive windows through which the first light is emitted from the keys and second light transmissive windows through which the second light is emitted.

12. The input device of claim 11, wherein the keys include light dams that prevent the first light from emitting from the keys through the second light transmissive windows and that prevent the second light from emitting from the keys through the first light transmissive windows.

13. The input device of claim 8, wherein both the first light devices emit the first light out of the keys and the second light devices emit the second light out of the keys responsive to operation in a third mode of operation.

14. The input device of claim 8, wherein a first key of the keys is actuated during operation in the first mode of operation to direct the system to display a first output on an output device and the first key is actuated during operation in the second mode of operation to direct the system to display a different, second output on the output device.

15. A method comprising:
forming a first light transmissive window in an exterior of a key in an input device of a system;
placing a first light device and a second light device in the key of the input device such that the first light device emits light out of the key through the first light transmissive window responsive to activation of the first light device; and
operatively coupling the first light device and the second light device with one or more processors of the system such that the one or more processors control the activation the first light device to emit the light out of the key responsive to a selected mode of operation being a first mode of operation and to stop emitting the light out of the key responsive to the selected mode of operation being a different, second mode of operation, the one or more processors controlling the second light device to emit light out of the key responsive to the selected mode of operation being the second mode of operation.

16. The method of claim 15, wherein forming the first light transmissive window includes etching an alphanumeric symbol through a thickness of the exterior of the key.

17. The method of claim 15, further comprising placing a key cover above the first light device and forming an exterior coating over the key cover and the first light device such that the key cover is between the first light device and the exterior coating.

18. The method of claim 17, further comprising forming an interior coating on the key cover such that the exterior coating is formed on the interior coating.

19. The method of claim 15, further comprising:
forming a second light transmissive window in the exterior coating of the key; and
placing the second light device in the key such that the second light device emits light out of the key through the second light transmissive window.

20. The method of claim 19, wherein placing the first light device includes placing the first light device on a first side of a light dam and placing the second light device includes placing the second light device on an opposite, second side of the light dam such that the light dam prevents the light emitted by the first light device from exiting the key through the second light transmissive window.
